(19) United States
(12) Patent Application Publication
(10) Pub. No.: US 2021/0344256 A1
(43) Pub. Date: Nov. 4, 2021

(54) ROTOR AND MACHINE HAVING SUPERCONDUCTING PERMANENT MAGNETS

(71) Applicant: Rolls-Royce Deutschland Ltd & Co KG, Blankenfelde-Mahlow (DE)

(72) Inventor: Peter Kummeth, Herzogenaurach (DE)

(21) Appl. No.: 17/282,394

(22) PCT Filed: Sep. 24, 2019
(86) PCT No.: PCT/EP2019/075643

§ 371 Date: Apr. 2, 2021

(30) Foreign Application Priority Data
Oct. 2, 2018 (DE) 10 2018 216 890.3

(51) Int. Cl. H02K 11/01; H01F 6/06; H02K 55/02; H02K 1/27

(52) U.S. Cl. CPC H02K 11/012; H01F 6/06; H02K 1/278; H02K 55/02; H02K 11/0141

(57) ABSTRACT

The invention relates to a rotor (5) for an electric machine (1) having a central rotor axis (A). The rotor comprises a rotor carrier (7), at least one superconducting permanent magnet (9) carried mechanically separately by the rotor carrier (7), and a damper shield having at least one shielding element (13a, 13i), which surrounds the at least one superconducting permanent magnet (9) and which is formed from an electrically conductive material having an electric conductivity of less than 30·10⁶ S/m. The invention further relates to an electrical machine (1) having a rotor (5) of this kind.

This application is the National Stage of International Application No. PCT/EP2019/075643, filed Sep. 24, 2019, which claims the benefit of German Patent Application No. DE 10 2018 216 890.3, filed Oct. 2, 2018. The entire contents of these documents are hereby incorporated herein by reference.

### BACKGROUND

The present embodiments relate to a rotor for an electrical machine, and an electrical machine with such a rotor.

The prior art discloses electrical machines that have a stator and a rotor and in which the rotor is configured to generate an electromagnetic excitation field. Such an excitation field may be generated either by permanent magnets that are arranged on the rotor or by coil elements that are arranged on the rotor. Rotors with superconducting coil elements are sometimes used for electrical machines with particularly high power densities. Another possible way of achieving particularly high power densities is the use of superconducting permanent magnets.

The power density of an electrical machine scales with the magnetic flux density that may be generated by the electromagnets or permanent magnets used in the electrical machine. This relationship allows a significant increase in the power density without a significant change in the topology of the electrical machine if, for example, conventional permanent magnets are replaced by superconducting permanent magnets, since higher magnetic flux densities may be generated with these.

One approach to increasing the power density is therefore to equip an electrical machine with permanent magnets composed of superconducting materials. At correspondingly low temperatures, materials of this kind may generate magnetic flux densities in orders of magnitude that are a multiple of the flux densities that may be generated with conventional permanent magnets. For example, it is possible to use a magnet composed of YBCO (yttrium-barium-copper oxide) at approximately 30 K to generate a magnetic field with a magnetic flux density of up to 8 T, while a conventional magnet, for example, consisting of NeFeB generates flux densities in orders of magnitude of approximately 1.2 T.

DE102016205216A1 describes an electrical machine having a superconducting permanent magnet and also a method for magnetizing the permanent magnet. Before being operated, superconducting permanent magnets first have to be magnetized at a cryogenic temperature below the critical temperature of the superconductor and then permanently kept at such a cryogenic temperature. A permanent magnetization state is achieved owing to the loss-free flow of current in the superconductor material. However, in order to maintain this over a relative long period of time too, both electromagnetic losses and also other undesired heating of the superconductor are to be reliably avoided.

Converters that generate alternating electromagnetic fields and harmonics are typically required for operating electrical machines. These alternating fields generate eddy currents in the electrically conductive elements of the electrical machine, which leads to heating of these conductive elements. One problem with the use of superconducting permanent magnets for generating the excitation field is that these permanent magnets are also electrically conductive and are exposed to the described alternating fields in the region of the rotor. The magnetization of the permanent magnets gradually decreases due to the interaction of the permanent magnets with these alternating fields. The heat generated indirectly by this electromagnetic interaction in the region of the permanent magnets may also lead to a loss of magnetization if the heat is not dissipated efficiently enough.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a rotor for an electrical machine that overcomes problems in connection with the operation of a superconducting permanent magnet is provided. For example, a rotor that has a superconducting permanent magnet, where a gradual loss of magnetization during operation of the rotor is effectively reduced in comparison to the prior art, is provided. As another example, an electrical machine having such a rotor is provided.

The rotor according to one or more of the present embodiments is configured as a rotor for an electrical machine. The rotor has a central rotor axis A. The rotor includes a rotor support, at least one superconducting permanent magnet that is mechanically supported by the rotor support, and a damping shield with at least one shielding element. This shielding element surrounds the at least one superconducting permanent magnet and is formed from an electrically conductive material with a conductivity σ of at least 30·10⁶ S/m.

In the present context, a superconducting permanent magnet may be an element that includes a superconductor material and may be brought into a permanently magnetized state by being magnetized at a cryogenic temperature and maintaining this cryogenic temperature. The described rotor may include, for example, a plurality of such superconducting permanent magnets in order to be able to generate a multi-pole magnetic field.

The at least one superconducting permanent magnet is intended to be mechanically supported by the rotor support. For example, the superconducting permanent magnet or, if appropriate, the plurality of such permanent magnets may be arranged on a radially outer side of the rotor support for this purpose. The permanent magnets may optionally be embedded in suitable recesses on the outer surface of the rotor support. As an alternative, the permanent magnets may also be pushed into internal recesses of the rotor support (e.g., from one axial end).

A substantial advantage of the rotor according to the present embodiments is that a major portion of the alternating electromagnetic fields that occur during operation of the machine is shielded by the external damping shield. Therefore, this shielded portion of the alternating fields does not electromagnetically interact with the superconducting permanent magnet/magnets. In this way, the loss of magnetization (e.g., both the loss due to the direct electromagnetic interaction and also the indirect loss due to heating of the permanent magnet/magnets caused thereby) is effectively reduced.

The shielding element may, for example, radially circumferentially surround the at least one permanent magnet. In this way, particularly effective shielding of alternating electromagnetic fields from regions that are situated radially further on the outside is provided. In addition, it is optionally also possible, but not absolutely necessary, for sheathing and therefore further shielding to also be present on the axially terminal sides of the permanent magnet. In contrast to the radially outer sides, these two axially terminal sides are often also referred to as end sides of the rotor. However, in connection with the present embodiments, shielding in the region of the radially outer sides of the permanent magnet is to be provided.

Choosing a material for the shielding element with an electrical conductivity in the stated range of values provides that adequate shielding of the potentially present alternating electromagnetic fields takes place. For example, the shielding element is intended to be an additional element of the rotor that is not already part of the rotor support or part of a cryostat that is required for cooling under certain circumstances. The core idea of the present embodiments is therefore to provide a damping shield in the form of at least one additional shielding element that is not already required as a mechanically supporting element or as a thermally insulating element of the rotor.

The electrical machine according to the present embodiments has a rotor according to the present embodiments and a stator that is arranged in a fixed manner. The advantages of the machine according to the present embodiments are obtained in a manner similar to the described advantages of the rotor according to the present embodiments.

The described refinements of the rotor and of the electrical machine may be combined with one another.

In general, the rotor may include a cooling apparatus with which the at least one superconducting permanent magnet may be cooled to a cryogenic operating temperature below the critical temperature of the superconductor used. For example, the cooling apparatus may be configured such that the rotor support, together with the at least one permanent magnet, is cooled to this cryogenic operating temperature.

The cooling apparatus may include, for example, at least one cryostat within which the rotor winding is arranged. For example, a fluid coolant that cools the at least one superconducting permanent magnet and the rotor support may be introduced into such a cryostat. The cooling apparatus may include a closed coolant circuit in which such a fluid coolant may circulate. The cryostat may have a vacuum space for better thermal insulation. This vacuum space may be, for example, an annular vacuum space that radially surrounds the rotor support and the at least one permanent magnet arranged thereon.

In general, the at least one shielding element may have a thickness of, for example, at least 0.1 mm or at least 1 mm. The combination of a high wall thickness of this kind with the above-described high electrical conductivity of the material provides correspondingly reliable shielding of alternating electromagnetic fields.

According to an embodiment, the material of the at least one shielding element may include copper and/or aluminum. For example, one of the metals mentioned may be present as the main constituent of the shielding element. The shielding element may consist substantially of one of the metals mentioned. These two metals are suitable for producing highly conductive elements (e.g., if the two metals have a very high degree of purity). If the damping shield has a plurality of separate shielding elements, either some of these shielding elements or each of these shielding elements may be formed from one of the preferred materials mentioned and/or with a wall thickness in the preferred range.

According to a first embodiment variant, the damping shield may include an external shielding element that radially surrounds the rotor support and the at least one superconducting permanent magnet. For example, such a rotor may also include a plurality of superconducting permanent magnets, where the external shielding element then radially surrounds this plurality of permanent magnets together with the rotor support.

For example, the rotor support and the permanent magnet(s) may be radially circumferentially enclosed by such an external shielding element. Such an external shielding element may be shaped as a hollow-cylindrical element. A circular-cylindrical shape may be provided.

In the embodiments in which the rotor includes a cryostat, the cryostat may, for example, radially encloses the rotor support and permanent magnet(s), and the external shielding element may radially enclose the cryostat. The substantial advantage of such an embodiment is that the rotor support and the permanent magnet(s) may be cooled together within the cryostat, while the external shielding element is at a comparatively warm temperature. The losses occurring due to the electromagnetic shielding in the shielding element then do not occur in the cold. In this way, undesired development of heat in the cryogenic region of the rotor may be avoided or at least largely reduced. The shielding element may be cooled substantially more easily and efficiently in the warm region of the rotor than would be the case in the cryogenic region of the rotor.

In the embodiments with an external shielding element, the shielding element may, in general, be provided with a plurality of cooling fins on an outer surface of the shielding element. Such an external shielding element may, for example, delimit the rotor radially to the outside in the direction of the air gap of the electrical machine. In one embodiment, the air gap is arranged radially between the rotor and the stator. The embodiment with external cooling fins has the advantage that the heat released due to the shielding of the alternating fields in the shielding element may be dissipated particularly easily via the air gap. In other words, the air gap may then be used for air cooling of the external shielding element. The effectiveness of such air cooling is improved by the cooling fins described.

As an alternative or in addition to the cooling fins, the rotor may have one or more fan impellers in order to cool the outer surface of the rotor (e.g., and that of the external shielding element) during operation. For example, such fan impellers create an additional air flow through the air gap arranged between the rotor and the stator during the rotation of the rotor. Flow that is intensified in this way causes yet further improved dissipation of the heat released in the external shielding element.

As an alternative or in addition, such an increased air flow in the air gap may also be created by an additional external fan that, in contrast to the variant described above, is not itself part of the rotor. Such a fan may be arranged, for example, axially next to the rotor and accordingly introduce an air flow into the air gap from an axially terminal side (e.g., an end side).

In the embodiments with an external shielding element, this shielding element may, in general, be surrounded by an additional radially outer holding element. Such a holding element is advantageous when, for example, the external shielding element is formed from a comparatively soft material (e.g., copper or aluminum). The holding element may then prevent or at least reduce deformation of the external shielding element as a result of the centrifugal forces during the rotation of the rotor. For this purpose, the holding element may be formed from a mechanically stronger material than the external shielding element. For example, the holding element may include stainless steel (e.g., non-magnetic stainless steel) and/or include a non-metallic binding band. Such a non-metallic binding band may include, for example, a glass fiber-reinforced plastic or a carbon fiber-reinforced plastic.

Further, in the embodiments with an external shielding element, it is, in general, advantageous if the rotor has an annular vacuum space that is arranged radially between the external shielding element and the rotor support with the at least one permanent magnet. In such an embodiment variant, the external shielding element is thermally well insulated from the rotor support and the at least one permanent magnet by the vacuum space, so that the external shielding element may be at a significantly higher temperature than the cryogenic elements situated further on the inside during operation of the rotor. This generally facilitates the dissipation of the heat released in the external shielding element. As an alternative or in addition to the annular vacuum space, another type of thermal insulation may also be arranged radially between the shielding element and the rotor support (e.g., an additional superinsulation film within the vacuum space).

As an alternative or in addition to the external shielding element described, the damping shield may have at least one internal shielding element. Such an internal shielding element is respectively associated with at least one superconducting permanent magnet. Instead of a single superconducting permanent magnet, the internal shielding element may, for example, also be associated with a group of such superconducting permanent magnets. The internal shielding element surrounds the associated superconducting permanent magnet or the corresponding group locally in each case. This may be that the internal shielding element, together with the at least one associated superconducting permanent magnet, is mechanically supported by the rotor support. The internal shielding element and the permanent magnet(s) therefore together form a unit that is also referred to as a shielded magnetic element below. Such a shielded magnetic element may, for example, again be arranged in a corresponding cavity in the rotor support. In this case, a portion of the internal shielding element is located between the at least one permanent magnet and the rotor support, so that, for example, direct contact between the permanent magnet/magnets and the rotor support is avoided. The shielded magnetic element may, for example, form a prefabricated component. Such a prefabricated component including the internal shielding element and the at least one associated superconducting permanent magnet may be embedded in an associated cavity of the rotor support (e.g., during production of the rotor as a whole).

If a group of permanent magnets that belong together are enclosed by an internal shielding element together, the group of permanent magnets may form a magnetic pole together.

Since the internal shielding element, together with the permanent magnet/magnets, is held on the rotor support, the internal shielding element may also be at a cryogenic temperature during operation of the rotor. This has the additional advantage, for electromagnetic shielding, that the electrical conductivity in the case of a metallic material of the internal shielding element is further increased due to the cryogenic temperature. For example, the electrical conductivity of aluminum or copper is significantly higher at a cryogenic temperature than at room temperature. As a result of this effect, a smaller layer thickness may be used for an internal shielding element than in the case of a comparable external shielding element given a comparable material. For example, the layer thickness of such an internal shielding element may be in the range of from 0.1 mm to 10 mm.

In an embodiment with one or more internal shielding elements, according to a first variant, these may be present in addition to an external shielding element, as has been described further above. In the case of such a combination, the entire damping shield may therefore be a purely functional unit and is formed from a plurality of spatially separated shielding elements. Such a composite damping shield fulfills, overall, the function of electromagnetic shielding of the at least one permanent magnet from undesired alternating fields.

In the case of such a combination of an external shielding element and at least one internal shielding element, the relative shielding effect of the individual shielding elements may be selected to be different in principle. For example, it may be advantageous if the external shielding element provides the major portion of the shielding present overall. A substantial advantage of this variant may be that the major portion of the heat released due to the shielding may then be dissipated in the external, relatively warm environment. However, as an alternative, it is also possible for the shielding effect of the at least one internal shielding element to be similar or even greater. This variant may be advantageous in order to achieve effective shielding with correspondingly less additional shielding material and/or in order to simplify the production of the rotor.

However, as an alternative to the combination of internal and external shielding described above, it is also possible for only one or more internal shielding elements to be present. For example, there is then no additional external radially enveloping element with the high electrical conductivity described. In this embodiment, the shielding of the alternating electromagnetic fields is therefore provided substantially in the direct local environment of the at least one superconducting permanent magnet. Since an additional external shielding element is dispensed with here, the production of the rotor may, under certain circumstances, be simpler than in the case of the variants described further above. In addition, the air gap may be made thinner. As a result of this, the electromagnetic interaction between the stator and the rotor may be improved.

In the embodiments that have at least one internal shielding element, this internal shielding element may be thermally coupled comparatively more strongly to the rotor support than to the at least one associated superconducting permanent magnet. In the case of a plurality of internal shielding elements, this may be the case, for example, for each of these shielding elements. In other words, in such an embodiment, the thermal resistance between the internal shielding element and the rotor support is smaller than the thermal resistance between the internal shielding element and the superconducting permanent magnet/magnets. A substantial advantage of this embodiment is that the heat released due to the shielding in the internal shielding element may easily be dissipated via the rotor support to a cooling apparatus of the rotor without leading to significant heating of the superconducting permanent magnet. Such indirect heating of the permanent magnets should be avoided since the indirect heating would also lead to an undesired loss of magnetization. The described embodiment therefore allows the alternating fields to be shielded in the immediate vicinity of the superconducting permanent magnet, but noticeable heating of the permanent magnet is advantageously avoided in spite of this.

In order to accordingly adapt the thermal resistance between the internal shielding element and the at least one associated superconducting permanent magnet, a thermal insulation layer may be arranged between these elements. In general, such a thermal insulation layer may be formed from a material with a thermal conductivity of at most 2 W/mK. For example, the thermal insulation layer may be formed from a polymer or a polymer-containing material (e.g., from a filled or unfilled epoxy resin such as Stycast 1266 or Stycast 2850FT). In general and regardless of the exact choice of material, such a thermal insulation layer may have, for example, a layer thickness between 0.2 mm and 1 mm. Such a layer thickness is high enough to provide sufficient thermal insulation that heating of the permanent magnet owing to the heating in the shielding element may be effectively reduced. At the same time, the layer thickness is small enough to still be able to cool the superconducting permanent magnet, together with the rotor support, to a cryogenic temperature.

In an embodiment with one or more internal shielding elements, these may each be composed of a shielding vessel and a shielding cover. In this embodiment, both the shielding vessel and the shielding cover may each be made from a correspondingly highly conductive material and optionally with a corresponding suitable wall thickness (as described above). In this variant, the vessel and the cover therefore together form a correspondingly enveloping shielding element. One advantage of such an embodiment may be provided by correspondingly simpler manufacture. For example, the shielding vessel may be firmly embedded in the rotor support and, under certain circumstances, manufactured together with the rotor support. The insertion of the at least one superconducting permanent magnet into this shielding vessel and the subsequent mounting of the shielding cover may then take place afterward.

In general, the at least one superconducting permanent magnet may include, for example, a high-temperature superconducting material. High-temperature superconductors (HTS) are superconducting materials with a critical temperature above 25 K or, in the case of some material classes (e.g., cuprate superconductors), above 77 K, where the operating temperature may be achieved by cooling with cryogenic materials other than liquid helium. Therefore, HTS materials are also attractive since these materials may have high upper critical magnetic fields and high critical current densities, depending on the choice of operating temperature.

The high-temperature superconductor may include, for example, magnesium diboride or a ceramic oxide superconductor (e.g., a compound of the type REBa₂Cu₃Oₓ (abbreviation: REBCO), where RE is a rare-earth element or a mixture of such elements).

In general and regardless of the choice of material, a plurality of superconducting permanent magnets that may form the magnetic poles of the rotor either in each case individually or in groups may be present in the rotor. In principle, any shapes are possible for the individual permanent magnets. For example, the permanent magnets may, for example, each have a cuboidal shape that allows comparatively simple production.

According to a first embodiment variant, the at least one superconducting permanent magnet may be formed by a stack of a plurality of superconducting strip conductors. Such a superconducting strip conductor typically has a thin superconducting layer on a strip-like support substrate. In this case, further layers may additionally optionally be present in between and/or above or below the layers mentioned. For example, a plurality of such superconducting strip conductors may then be stacked one on top of the other in the radial direction with respect to the rotor axis. However, in principle, the main direction of stacking may also be oriented differently. In addition, a plurality of individual strip conductors may also be present next to one another in the stack in the circumferential direction and/or in the axial direction. The strip conductors of the entire stack may optionally also be arranged offset in relation to one another between the individual stack layers, where, for example, the orientation of the individual strips (e.g., the position of their longitudinal direction) may also change from stack level to stack level. In any case, simple shaping of the superconducting permanent magnet and, for example, the formation of a desired size is possible in a simple manner due to the formation of strip conductor stacks. Cuboidal permanent magnets may be produced particularly easily in this way. In general, the superconducting permanent magnets formed as a stack of strip conductors may be produced as prefabricated components and then inserted as a whole into a corresponding cavity in the rotor support, where the superconducting permanent magnets may optionally be surrounded beforehand by an internal damping shield.

However, according to an alternative second embodiment variant, the at least one superconducting permanent magnet may also be formed by a superconducting bulk element. Here, such a bulk element may be a one-piece element composed of superconducting material. Such bulk elements may be produced, in principle, with any desired geometries. For example, permanent magnets may also be provided relatively easily in the form of a cuboid. Materials for such bulk elements are once again, for example, magnesium diboride and REBCO.

According to an embodiment of the electrical machine, the stator may be configured as a liquid-cooled stator. This may be provided, for example, in embodiments with an external shielding element since the heat released in this shielding element may then also be at least partially dissipated across the air gap via the cooling system of the stator.

The machine and, respectively, the rotor may be configured for a rated power of at least 5 MW or at least 10 MW. With such a high power, the machine is suitable, in principle, for driving a vehicle (e.g., an aircraft). However, as an alternative, it is also possible to use a powerful machine of this kind to produce the electrical power required for driving on board the vehicle during operation as a generator. In principle, the machine may be embodied either as a motor or as a generator or optionally configured for both modes of operation. The machine may be, for example, a permanent-magnet synchronous machine. In order to achieve the high powers described, high-temperature superconducting elements are particularly suitable since the high-temperature superconducting elements allow particularly high current densities.

### BRIEF DESCRIPTION OF THE DRAWINGS

FIG. 1 shows a schematic cross section through a first embodiment of an electrical machine;

FIG. 2 shows a schematic cross section through a second embodiment of the electrical machine; and

FIGS. 3 to 6 show details of similar machines in the field of superconducting permanent magnets.

### DETAILED DESCRIPTION

In the figures, elements that are the same or have the same function are provided with the same reference signs.

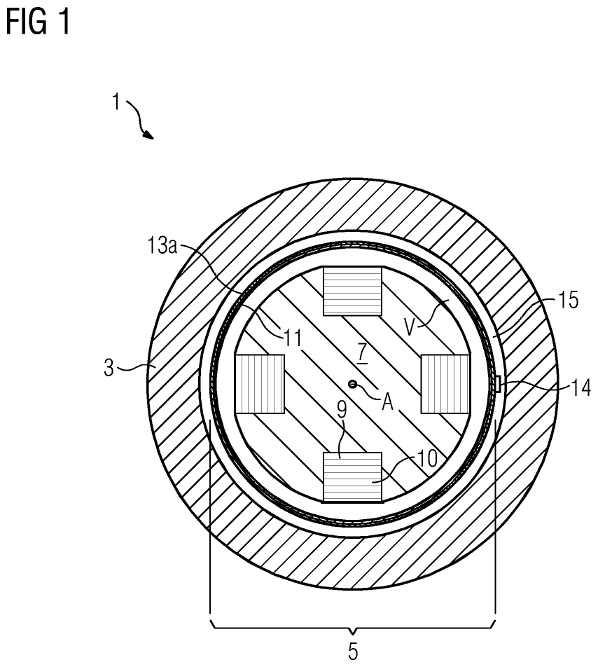

FIG. 1 shows a schematic cross section of one embodiment of an electrical machine 1. In other words, FIG. 1 shows the electrical machine 1 perpendicularly to a central axis A. The electrical machine 1 includes an external stationary stator 3 and an internal rotor 5 that is rotatably mounted about the central axis A. The electromagnetic interaction between the rotor 5 and the stator 3 takes place across an air gap 15 situated between the rotor 5 and the stator 3. The electrical machine 1 is a permanently excited machine that has a plurality of superconducting permanent magnets 9 in order to form an excitation field in a region of the rotor 5. In the cross section of FIG. 1, four (4) permanent magnets 9 of this kind are distributed over a circumference of the rotor 5 by way of example. The permanent magnets 9 are arranged in corresponding radially outer recesses of a rotor support 7, where the rotor support 7 mechanically supports the permanent magnets 9. However, yet further permanent magnets 9 than the four shown in FIG. 1 may also be present in the axial direction (not shown in in Figure), where the number of magnetic poles of the electrical machine is not increased by such an axial subdivision, however.

The rotor support 7, together with the permanent magnets 9 held thereon, is cooled to a cryogenic operating temperature that is below the critical temperature of the superconductor material used in the permanent magnets 9, by a cooling apparatus (not shown in any detail). In order to maintain this cryogenic temperature, the rotor support 7 and the permanent magnets 9 are arranged in the interior of a cryostat 11 together. There is an annular vacuum space V for thermal insulation between the cryostat and the rotor support 7. In the exemplary embodiment of FIG. 1, a damping shield of the rotor 5 is implemented by an external shielding element 13a. The external shielding element 13a is configured as a metallic hollow cylinder that radially encloses the outer wall of the cryostat 11. In this way, the elements 7 and 9 situated further on the inside are also radially surrounded by the external shielding element 13a. As a result, alternating electromagnetic fields from regions that are situated radially even further on the outside may be effectively shielded by the external shielding element 13a, so that interaction of such fields with the superconducting permanent magnets is greatly reduced. The heat released in the external shielding element 13a by the eddy currents that occur, for example, may be dissipated in the direction of the air gap 15. In order to increase the heat dissipation in the direction of the air gap, the external shielding element 13a may be provided, on an outer surface of the external shielding element 13a, with a plurality of cooling fins 14, only one of which is shown in FIG. 1 by way of example. The cooling fins may (as indicated here) either extending axially, or the cooling fins may be annular cooling fins in the circumferential direction or else cooling fins oriented in some other way (e.g., also in a spiral shape). The heat generated in the region of the external shielding element may, in addition to the air cooling described, also be dissipated by a cooling system provided in the region of the stator for cooling the stator winding (not shown in detail in FIG. 1).

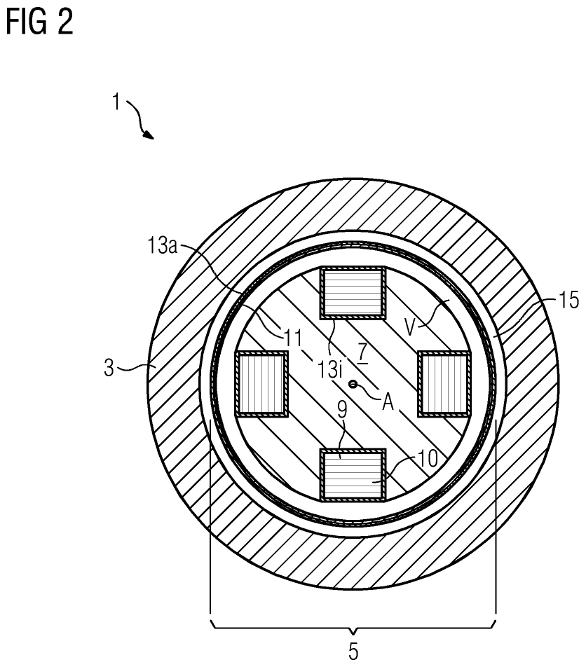

FIG. 2 shows a schematic cross section through an alternative embodiment of an electrical machine 1. The electrical machine 1 is configured similarly to the machine of FIG. 1 in principle. In contrast to this, however, the electrical machine 1 also has an internal shielding element 13i around each superconducting permanent magnet 9. In the example shown in FIG. 2, these internal shielding elements 13i are provided in addition to the external shielding element 13a already described. Therefore, the internal shielding elements 13i form the superordinate damping shield together with the external shielding element 13a. However, as an alternative, the alternating electromagnetic fields may also be shielded predominantly or even exclusively by the inner shielding elements 13i. The external shielding element 13a is therefore to be regarded as optional for this exemplary embodiment.

The internal shielding elements 13i therefore provide local shielding of the alternating fields (e.g., remaining alternating fields) in the region of the superconducting permanent magnets 9. The internal shielding elements 13i are arranged locally around the superconducting permanent magnets 9, so that the internal shielding elements 13i also fill an intermediate space between the permanent magnets 9 and the rotor support 7. Each of the superconducting permanent magnets 9 is therefore completely enveloped at least in a radial direction by a respectively associated internal shielding element 13i. It is possible for precisely one such internal shielding element 13i to be associated with each permanent magnet 9. However, as an alternative, a plurality of permanent magnets 9 may also be surrounded in groups by a common inner shielding element 13i. For this purpose, a plurality of permanent magnets 9 may be arranged one behind the other, for example, within a common inner shielding element 13i in the axial direction (not shown in FIG. 2). The inner shielding elements 13i are also formed from an electrically highly conductive material and may therefore effectively shield the alternating electromagnetic fields present from the inside by forming eddy currents and therefore avoid direct interaction of these fields with the superconducting permanent magnet 9. The heat released as a result in the region of the inner shielding elements 13i may be dissipated via the rotor support 7, which is thermally coupled to the cooling system. For this purpose, the thermal resistance between the elements 13i and 7 may be smaller than the thermal resistance between the elements 13i and 9.

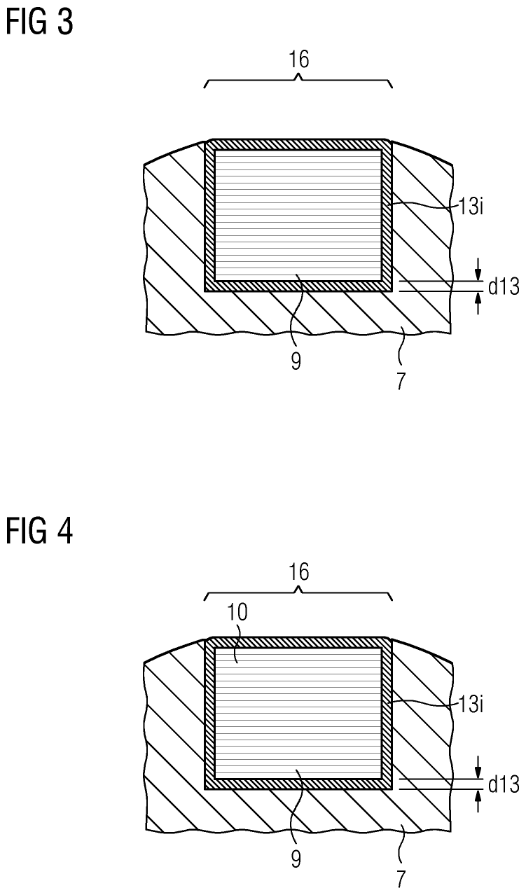

FIG. 3 shows a schematic cross section through a detail of the rotor of one embodiment of an electrical machine. FIG. 3 shows the region of a superconducting permanent magnet 9 that is embedded in a radially outer cavity of a rotor support 7. The remaining portion of the electrical machine may be configured, for example, similarly to the machine of FIG. 2. The permanent magnet 9 of FIG. 3 is also locally surrounded by an internal shielding element 13i, so that the permanent magnet 9, together with the internal shielding element 13i, forms a shielded magnetic element 16. This shielded magnetic element 16 may be produced as a prefabricated component and accordingly becomes embedded as a whole in the matching cavity of the rotor support 7. Yet further similar permanent magnets 9 may optionally be arranged as a group within a common shielding element 13i in the axial direction too (not shown). In the example of FIG. 3, the superconducting permanent magnet 9 is configured as a superconducting bulk element. For example, the superconducting permanent magnet may be a one-piece cuboid composed of YBCO or magnesium diboride. The material of the internal shielding element 13i may, in turn, include, for example, aluminum or copper as the main constituent. The thickness of the internal shielding element 13i is indicated by d13, for example. This thickness may be, for example, in the region of 2 mm. Good electromagnetic shielding of the alternating fields may be provided given a wall thickness of this kind. Due to the radially circumferential arrangement of the inner shielding element 13i, the permanent magnet 9 and the rotor support 7 are spaced apart at least by this thickness d17.

FIG. 4 shows a detail of a rotor according to a further exemplary embodiment. The region around a superconducting permanent magnet 9 that, together with an internal shielding element 13i, forms a shielded magnetic element 16 is shown in FIG. 4 too. However, in contrast to the example of FIG. 3, the superconducting permanent magnet 9 is not formed as a one-piece superconductor here, but rather, as a stack of individual superconducting strip conductors 10. These individual strip conductors may be connected to one another by a suitable adhesive or some other connector to form a solid stacked package.

The individual superconducting strip conductors are each formed by a layer system including a superconducting layer and optionally a plurality of further electrically conductive and or insulating layers on a strip-like support substrate. The superconductor layer is comparatively thin in comparison to this support substrate, so that the superconductor layer only forms a small constituent part of the total material of the strip conductor stack. Nevertheless, even with such a superconducting strip conductor stack, comparatively high magnetic flux densities may be achieved for forming an excitation field.

FIG. 5 shows a detail of a rotor according to a further exemplary embodiment. In addition to the elements shown in FIG. 4, a thermal insulation layer 17 that is arranged circumferentially around the superconducting permanent magnet 9 between the superconducting permanent magnet 9 and the internal shielding element 13i is also shown. The thickness d17 of this thermal insulation layer 17 may be, for example, between 0.2 mm and 1 mm. The material of this insulation layer may be given, for example, by an epoxy resin with a comparatively low thermal conductivity. Such a thermal insulation layer may provide that the heat released due to the electrical shielding in the element 13i is dissipated substantially through the rotor support 7 to the cooling system of the rotor and makes only a minor contribution to heating of the superconducting permanent magnet 9. The permanent magnet 9 and the associated inner shielding element 13i are spaced apart at least by the thickness d17 owing to the additional thermal insulation layer. The permanent magnet 9 and the associated inner shielding element 13i may be spaced apart substantially precisely by this thickness. In the example of FIG. 5, the permanent magnet 9 is once again shown as a stack of individual superconducting strip conductors. However, as an alternative, the permanent magnet may also again be a bulk element, similarly to the example of FIG. 3.

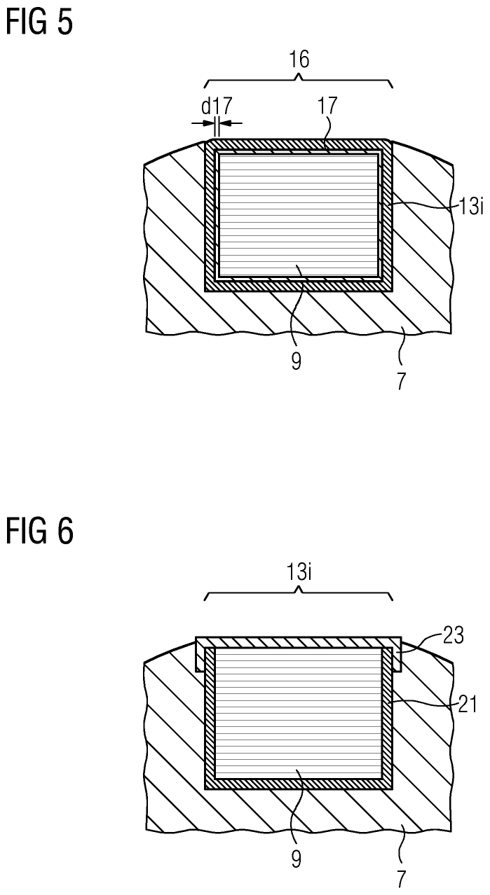

FIG. 6 shows a detail of a rotor according to a further exemplary embodiment. Instead of the unitary and, for example, one-piece inner shielding element 13i shown in FIG. 4, the superconducting permanent magnet 9 is surrounded by a two-part inner shielding element 13i. The inner shielding element 13i is formed by a shielding vessel 21 and a shielding cover 23. Both elements are formed continuously from a highly electrically conductive material and with a thickness suitable for shielding, as explained further above. For example, the slight lateral overlap between the shielding cover and the shielding vessel provides adequate shielding of the surrounding alternating electromagnetic fields with this two-part design, so that electrical interaction with the internal superconducting permanent magnet 9 is effectively avoided. In the example of FIG. 6, the permanent magnet 9 is once again shown as a stack of individual superconducting strip conductors. However, as an alternative, the permanent magnet may also again be a bulk element, similarly to the example of FIG. 3.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A rotor for an electrical machine with a central rotor axis, the rotor comprising:
a rotor support;
at least one superconducting permanent magnet that is mechanically supported by the rotor support; and
a damping shield with at least one shielding element that surrounds the at least one superconducting permanent magnet and is formed from an electrically conductive material with an electrical conductivity σ of at least 30·10⁶ S/m.

2. The rotor of claim 1, wherein the at least one shielding element has a thickness of at least 0.1 mm.

3. The rotor of claim 1, in which the electrically conductive material of the at least one shielding element comprises copper, aluminum, or copper and aluminum.

4. The rotor of claim 1, wherein the damping shield has an external shielding element that radially surrounds the at least one superconducting permanent magnet and the rotor support together.

5. The rotor of claim 4, wherein the external shielding element is provided with a plurality of cooling fins on an outer surface of the external shielding element.

6. The rotor of claim 1, wherein the damping shield has at least one internal shielding element that is associated with the at least one superconducting permanent magnet and surrounds the at least one superconducting permanent magnet locally such that the at least one internal shielding element, together with the at least one associated superconducting permanent magnet, is mechanically supported by the rotor support.

7. The rotor of claim 6, wherein the at least one internal shielding element is thermally more strongly coupled to the rotor support (7) than to the at least one associated superconducting permanent magnet.

8. The rotor of claim 7, further comprising a thermal insulation layer that is arranged between the at least one internal shielding element and the at least one associated superconducting permanent magnet.

9. The rotor of claim 6, wherein the at least one internal shielding element, together with the at least one associated superconducting permanent magnet, forms a prefabricated component.

10. The rotor of claim 6, wherein the at least one internal shielding element is composed of a shielding vessel and a shielding cover.

11. The rotor of claim 6, wherein the at least one superconducting permanent magnet comprises a plurality of superconducting permanent magnets that are surrounded either individually or combined in groups by respectively associated internal shielding elements,
wherein the internal shielding elements are each arranged at least partly between the associated superconducting permanent magnet and the rotor support.

12. The rotor of claim 1, wherein the at least one superconducting permanent magnet comprises a high-temperature superconducting material.

13. The rotor of claim 1, wherein the at least one superconducting permanent magnet is formed by a stack of a plurality of superconducting strip conductors.

14. The rotor of claim 1, wherein the at least one superconducting permanent magnet is formed by a superconducting bulk element.

15. An electrical machine comprising:
a rotor for an electrical machine with a central rotor axis, the rotor comprising:
a rotor support;
at least one superconducting permanent magnet that is mechanically supported by the rotor support; and
a damping shield with at least one shielding element that surrounds the at least one superconducting permanent magnet and is formed from an electrically conductive material with an electrical conductivity a of at least 30·10⁶ S/m; and
a stator that is arranged in a fixed manner.
